(19) United States
(12) Patent Application Publication
(10) Pub. No.: US 2014/0305537 A1
(43) Pub. Date: Oct. 16, 2014

(54) Fueling Station

(71) Applicant: Jie Lian, Beaverton, OR (US)

(72) Inventor: Jie Lian, Beaverton, OR (US)

(21) Appl. No.: 13/860,471

(22) Filed: Apr. 10, 2013

(51) Int. Cl. B60S 5/02; B67D 7/04

(52) U.S. Cl. CPC B60S 5/02; B67D 7/04
USPC 141/1; 141/237

(57) ABSTRACT

Conventional fueling station has an intrinsic limitation of congested traffic flow, leading to under utilization of fuel dispensers and causing long waiting lines. This invention discloses a novel structure of a fueling station and the method of improving the traffic flow in the fueling station. The disclosed fueling station comprises a passage for entrance, a passage for exit, at least a sequence of two or more fuel dispensers arranged sequentially between said passage for entrance and said passage for exit, wherein each fuel dispenser has at least one fueling space, and said fueling space is configured to enable a vehicle to move into and out of said fueling space without being hindered by another vehicle at a different fueling space.

### FIELD OF THE INVENTION

The present invention relates to a novel structure of a fueling station and the method of improving the operation efficiency of the fueling station by optimizing the utilization of the fuel dispensers and reducing the wait time of vehicles.

### BACKGROUND OF THE INVENTION

A fueling station typically refers to a facility that sells fuel for motor vehicles. The most common fuels sold today are gasoline, petrol, diesel fuel, and electric energy. Other types of fuels include, but are not limited to, compressed natural gas, compressed hydrogen, the mixture of compressed natural gas and hydrogen, liquefied petroleum gas, liquid hydrogen, ethanol fuel, biofuels like biodiesel, kerosene, etc. Filling stations that sell only electric energy are also known as charging stations.

A fueling station typically comprises a fuel storage apparatus (either underground or above ground), one or more fueling islands that include dispensers (such as gasoline pumps) for dispensing selected type of fuel to the vehicles, fueling lanes on one or both sides of each fueling island for vehicle parking, and means for connecting the fuel storage apparatus to the fueling islands (e.g. pipes for gasoline). Optionally, a fueling station can have other structural elements, such as a canopy, one or more vending machines, propane or butane tank, an air pump, etc. A convenience store is also often associated with a fueling station.

A fueling station is commonly installed with a plurality of fuel dispensers, each of which is usually equipped with multiple fuel pumps that can be used to pump fuels of various grades. Typically, each fuel dispenser can have fuel pumps installed on the opposing sides of the fuel dispenser, so that two vehicles can park at two fueling spaces located at the opposite sides of the fuel dispenser for fueling at the same time.

A known problem in existing fueling stations is traffic control. The fueling station is usually constructed within a limited space. To maximize the usage of such a limited space, the fueling station is usually constructed to have one or more fueling lanes; each fueling lane is served by a plurality of fuel dispensers. Such a design has an intrinsic limitation that can create heavy traffic in a crowded space. As a result, it is quite common to see long lines of vehicles at the fueling station waiting to be served, while there are empty fueling spaces near some unused fuel dispensers. This is mainly caused by the traffic congestion at the fueling station, where a vehicle waiting in line cannot easily drive into the empty fueling space. In addition, a vehicle that has completed fueling may be stuck in the fueling space because another vehicle parking at a neighboring fueling space may block its drive way. This traffic problem at the fueling station not only leads to reduced customer satisfaction (e.g. due to long waiting time), but also reduces the utilization rate of the fuel dispensers, and consequently lower revenue and profit. Moreover, it can lead to higher risk of traffic accidents and create safety problem. Therefore, there is a need to create a more efficient structure and method for designing the fueling stations to overcome the aforementioned limitations.

### SUMMARY OF THE INVENTION

It is an objective of this invention to provide a vehicle fueling station that has improved traffic flow.

is another objective of this invention to provide a means of maximizing the utilization rate of the fuel dispensers and minimizing the vehicle waiting time.

It is yet a further objective of this invention to reduce traffic accidents and improve safety at the fueling station.

According to this invention, the vehicle fueling station has a passage for entrance and a passage for exit. The vehicle fueling station has at least one sequence of fuel dispensers. Each sequence of fuel dispensers comprises two or more fuel dispensers that are arranged sequentially between the passage for entrance and the passage for exit. Each fuel dispenser has at least one fueling space that is located by at least one side of the fuel dispenser. Each of the fueling space has a first end and a second end for a vehicle to enter and exit said fueling space. For each sequence of fuel dispensers, a first passing lane is provided that connects to the first end of each fueling space associated with the said sequence of fuel dispensers. A second passing lane is provided that connects to the second end of each fueling space associated with the said sequence of fuel dispensers.

Hence, a vehicle can move into and out of an empty fueling space without being hindered by another vehicle at a different fueling space.

The unique advantages of the present invention will be appreciated by people of ordinary skill in the art after referring to the written description of the detailed embodiments in conjunction with the illustrative drawings.

### BRIEF DESCRIPTIONS OF THE DRAWINGS

FIG. 1 shows an exemplary layout of a typical fueling station.

FIG. 2 shows an exemplary scenario in a typical fueling station.

FIG. 3 shows an exemplary layout of a fueling station according to this invention.

FIG. 4 shows an exemplary scenario in a fueling station according to this invention.

FIG. 5 shows another exemplary layout of a fueling station with bidirectional traffic flow according to this invention.

### DETAILED DESCRIPTIONS OF THE EMBODIMENTS

Before describing the embodiments of the present invention, it is worthwhile to review the common design of existing fueling stations to understand their limitations.

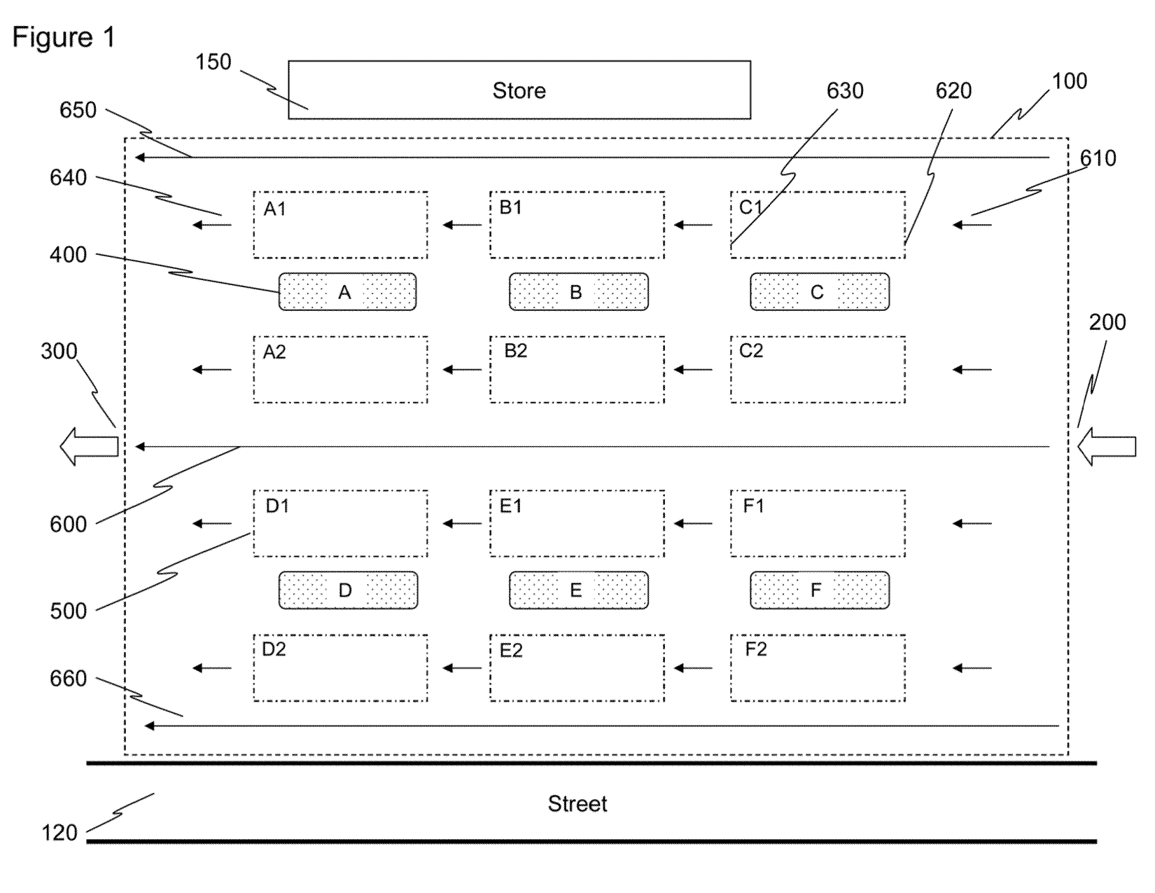

FIG. 1 shows an exemplary layout of a typical fueling station. In this example, the fueling station 100 is constructed by the side of a street 120, and has an associated convenience store 150. The fueling station 100 has an entrance passage 200 and an exit passage 300 In this example, the traffic flow in the fueling station 100 is shown to be unidirectional, i.e. the vehicles move from the entrance 200 to the exit 300. While not shown in the figure, it is understood that the passage 200 as well as the passage 300 can serve as both entrance and exit, and the traffic flow in the fueling station can be bidirectional.

In the example shown in FIG. 1, the fueling station 100 has six fuel dispensers 400, respectively labeled as A, B, C, D, F, and F. The depicted six fuel dispensers are arranged in two sequences, where each sequence consists of three fuel dispensers that are arranged sequentially between the entrance passage 200 and the exit passage 300. Specifically, one of the sequences consists of fuel dispensers A, B, and C, and the other sequence consists of fuel dispensers D, E, and F.

As known in the art, fuel dispenser usually has an elongated shape, and is usually designed to have fuel pumps installed on two opposing sides of the fuel dispenser so that it can serve two vehicles at the same time. In this example, each of the fuel dispensers 400 is associated with two fueling spaces 500 that have elongated shape and are located on the opposite sides of the fuel dispenser. The orientation of fueling spaces is substantially in parallel with the long axis of the associated fuel dispenser. In this example, fuel dispenser A is associated with fueling spaces A1 and A2, fuel dispenser B is associated with fueling spaces B1 and B2, fuel dispenser C is associated with fueling spaces C1 and C2, fuel dispenser D is associated with fueling spaces D1 and D2, fuel dispenser E is associated with fueling spaces E1 and E2, and fuel dispenser F is associated with fueling spaces F1 and F2.

As shown in this example, the fuel dispensers in a sequence are aligned in such a way that the fueling spaces on either side of the fuel dispensers generally form a fueling lane. For example, four fueling lanes are shown in this example: (1) A1-B1-C1, (2) A2-B2-C2, (3) D1-E1-F1, and (4) D2-E2-F2. Each fueling space (e.g. C1 as shown in FIG. 1) has a first end 630 for vehicle to enter and a second end 640 for vehicle to exit the fueling space. For each of the fueling lanes, the fueling spaces are lined up in a queue so that a vehicle exiting one fueling space enters an adjacent fueling space in the queue, except for the fueling spaces at both ends of the fueling lane. Assuming the traffic flow is unidirectional, a fueling vehicle entering the fueling station 100 through its entrance passage 200 will drive toward one end of a fueling lane 610, proceed to an empty fueling space in the fueling lane to complete fueling the vehicle, and then exiting the fueling lane at the other end 640, before leaving the fueling station 100 through its exit passage 300. Also shown in this example are three passing lanes 600, 650, and 660, each of which provides a driving path between the entrance passage 200 and the exit passage 300. A vehicle that has finished fueling may veer into the adjacent passing lane to exit the fueling station. However, such passing lanes are usually very narrow and may not even be available due to limited space of the fueling station or the spatial constraint of neighboring street/store. The direction of typical vehicle movement is shown by the solid arrows in this figure.

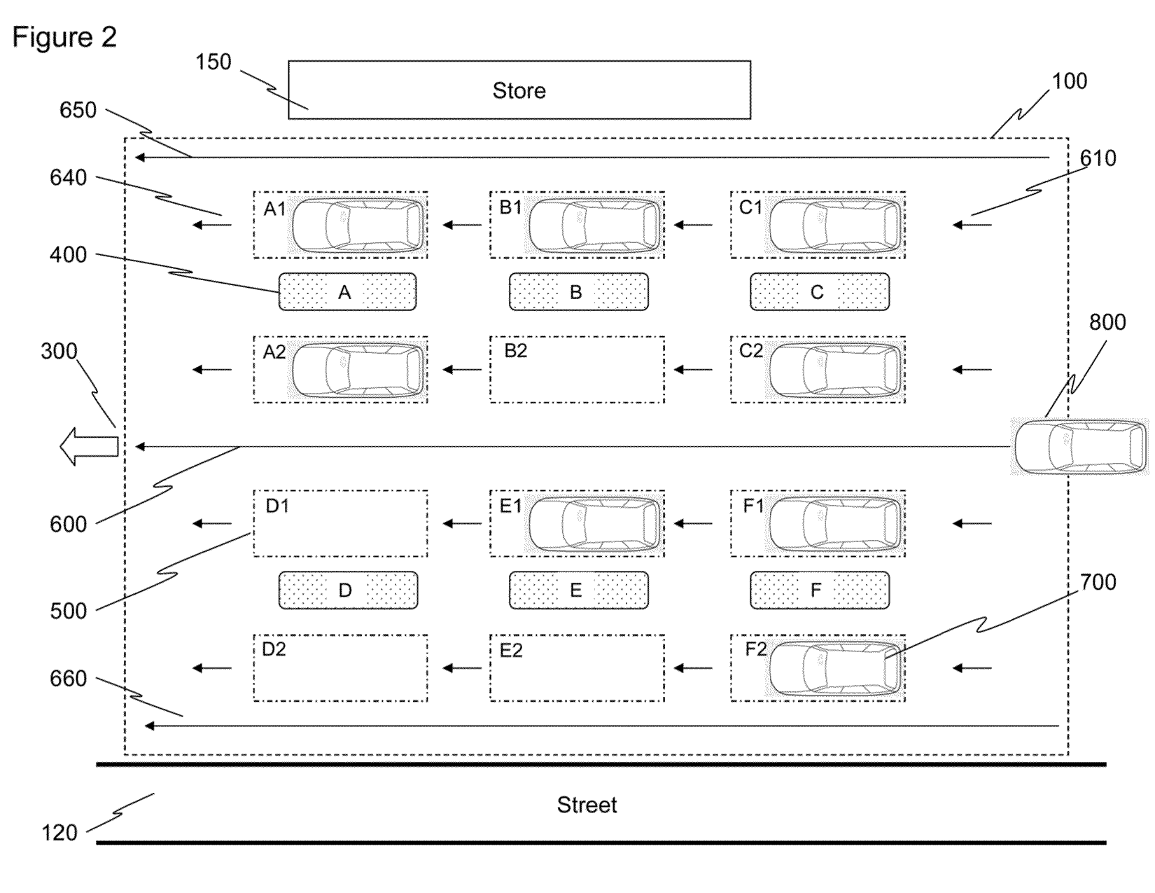

FIG. 2 illustrates an exemplary scenario in a typical fueling station as shown and described in FIG. 1. In this example, vehicles 700 have parked at the following eight fueling spaces for service: A1, B1, C1, A2, C2, E1, F1, and F2. Thus an incoming vehicle 800 will have four empty fueling spaces available to choose from: B2, D1, D2, and E2. However, because the nearest fueling spaces C1, C2, F1, and F2, which are all at the end of fueling lanes, are occupied, the incoming vehicle 800 is blocked from directly proceeding to any of the empty fueling spaces through the fueling lanes.

One way for the incoming vehicle 800 to get into one of the empty fueling spaces shown in this figure is through the passing lanes 600, 650, and 660, if they are available, For example, the incoming vehicle 800 may get into fueling space B2 or D1 through the passing lane 600, or get into fueling space D2 or E2 through the passing lane 600. However, this is often difficult because (1) the passing lanes are usually narrow due to space constraint, and (2) the fueling, spaces in as fueling lane are usually closely packed. For example, to access the empty fueling space B2, the incoming vehicle 800 may have to drive to the passing lane 600 and attempt parallel parking in order to squeeze into the empty fueling space B2 that is located between occupied fueling spaces A2 and C2. This is usually considered not only inconvenient but also risky, because this maneuver will require significant skills and patience of the driver. Lacking skills or patience while trying such a maneuver may pose significant risks of damaging the vehicles, causing people injuries, and blocking the traffic in the narrow passing lane. For example, while the incoming vehicle 800 is trying to get into the empty fueling space B2 through the passing lane 600, the vehicle at the fueling space F1 will not be able to use the passing lane 600 to exit the fueling station even after it has finished fueling, unless the fueling lane 600 is cleared or the fueling space E1 is emptied. Because of these concerns, the incoming vehicle 800 may choose to wait until one of the fueling spaces at the end of the fueling lanes (C1, C2, F1, and F2) is emptied. Obviously, this may lead to long waiting lines at the fueling station even though there are empty fueling spaces left unused.

The scenario described in the above example highlights the intrinsic limitations of the existing fueling stations. Arranging a sequence of multiple fuel dispensers in a queue is fundamentally insufficient, as it restricts the flow of traffic. To move forward, a vehicle must either follow the queue, or veer to an adjacent passing lane if it is available. Any other vehicle on the queue or the passing lane will block the traffic. Moreover, it is difficult to insert into an empty fueling space between two occupied fueling spaces from a passing lane. These limitations has caused many problems for existing fueling stations, such as low utilization rate, long waiting time, high safety risks, etc.

These problems are solved by this invention as described in details below.

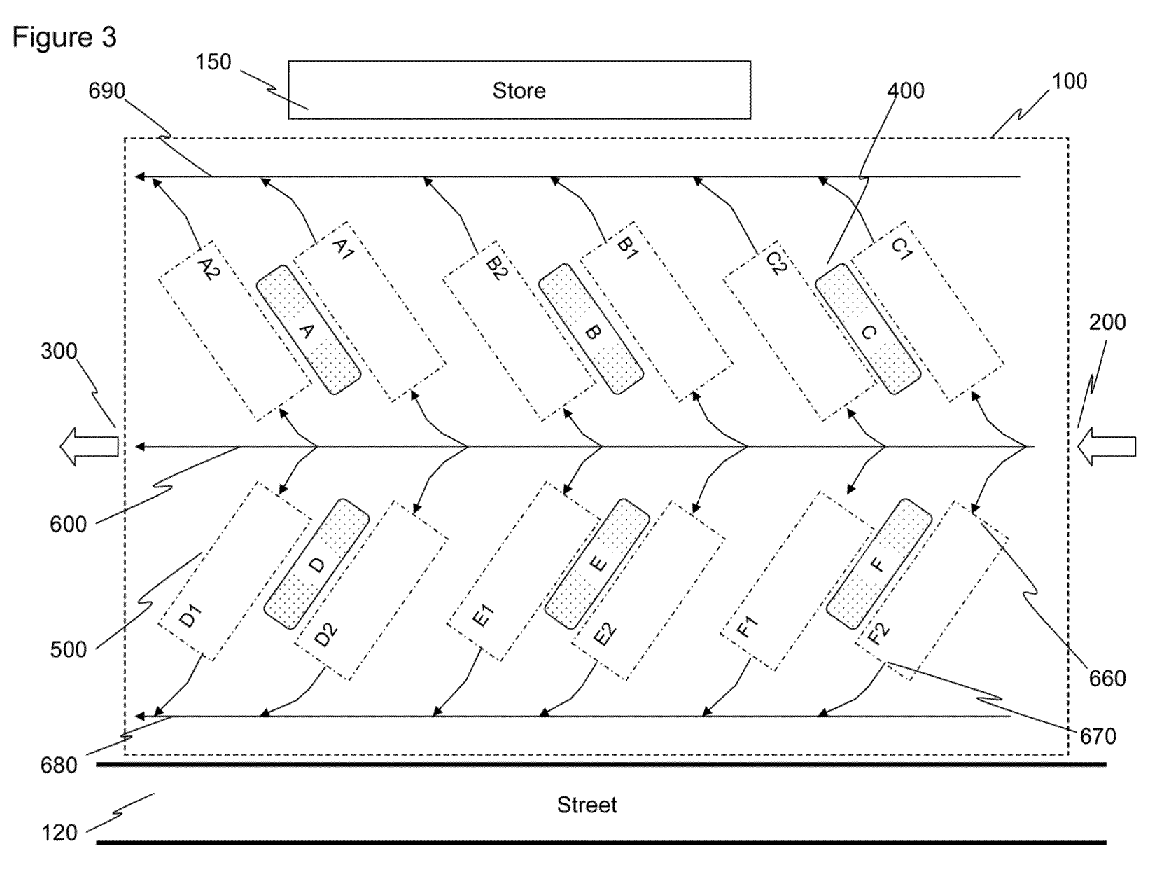

FIG. 3 shows an exemplary layout of a fueling station according to this invention. Similar to the previous examples, the fueling station 100 is constructed by the side of a street 120, and has an associated convenience store 150. The fueling station 100 has an entrance passage 200 and an exit passage 300, and the traffic flow is shown to be unidirectional, i.e. the vehicles move from the entrance 200 to the exit 300. Like in previous examples, the fueling station 100 has six fuel dispensers 400, respectively labeled as A, B, C, D, E, and F. Each of the fuel dispensers has an elongated shape and is associated with two elongated fueling spaces 500 that are located on the opposite sides of the fuel dispenser. Likewise, the orientation of fueling spaces is substantially in parallel with the long axis of the associated fuel dispenser.

Similarly, the depicted six fuel dispensers are arranged in two sequences, where each sequence consists of three fuel dispensers that are arranged sequentially between the entrance passage 200 and the exit passage 300. Specifically, one of the sequences consists of fuel dispensers A, B, and C, and the other sequence consists of fuel dispensers D, E, and F. According to this invention, a sequence of fuel dispensers are arranged sequentially if and only if all fuel dispensers in the sequence are connected to (i.e. are accessible from) at least one adjacent passing lane at different positions along the passing lane, wherein the passing lane provides a driving path between the entrance passage 200 and the exit passage 300.

In this example, three passing lanes 600, 680, and 690 are shown. The sequence of fuel dispensers A, B, and C can be accessed from either passing lane 600 or passing lane 690.

The sequence of fuel dispensers D, E, and F can be accessed from either passing lane 600 or passing lane 680. Although in this example, the passing lanes 600, 680, and 690 are plotted as straight lines, it should be understood that any of these passing lanes can be curved, as long as it provides a driving path between the entrance passage 200 to the exit passage 300. Because of the special orientation of the fuel dispensers and the associated fueling spaces as described below, more space can be saved to accommodate the passing lanes.

Different than previous examples, according to this invention, the fuel dispensers in a sequence are not aligned along their long axes. Instead, each of the fuel dispensers is arranged in such a way that its long axis forms an angle with each of its two adjacent passing lanes. For example, the fuel dispensers A, B, and C have oblique angles with the passing lanes 600 and 690, and the fuel dispensers D, E, and F have oblique angles with the passing lanes 600 and 680. Because each fuel dispenser is associated with two fueling spaces that are located on the opposite sides of the fuel dispenser and their orientations are substantially in parallel with the associated fuel dispenser, each of the fueling spaces also forms an oblique angle with each of its two adjacent passing lanes. For example, the fueling spaces A1, A2, B1, B2, C1, and C2 have oblique angles with the passing lanes 600 and 690, and the fuel dispensers D1, D2, E1, E2, F1, and F2 have oblique angles with the passing lanes 600 and 680. Note that none of the fueling spaces shown in this example is connected with any other fueling spaces.

Because the fueling spaces are oriented in oblique angles with the adjacent passing lanes, the fueling spaces associated with a sequence of fuel dispensers do not form a fueling lane that has a queuing structure. In other words, there is no straight pass for a vehicle exiting one fueling space to directly enter another fueling space. Instead, each fueling space (e.g. F2 as shown in FIG. 3) has a first end 660 for a vehicle to enter and a second end 670 for a vehicle to exit the fueling space, where the first end and the second end of said fueling space are respectively connected to two separate passing lanes. For example, each of the fueling spaces shown in this example is connected to the passing lane 600 at one end so that a vehicle can enter the fueling space. The other end of each of the fueling spaces A1, A2, B1, B2, C1, and C2 is connected to the passing lane 690, and the other end of each of the fueling spaces D1, D2, E1, E2, F1, and F2 is connected to the passing lane 680 for a vehicle to exit the fueling space.

Therefore, instead of entering or exiting a fueling space by following a fueling lane, a vehicle can enter or exit any of the fueling spaces independently. In other words, the operation of fuel dispensers and the usage of their associated fueling spaces become parallel, meaning that vehicles can enter or exit any of the fueling spaces freely without being hindered or blocked by vehicles parking at the other fueling spaces.

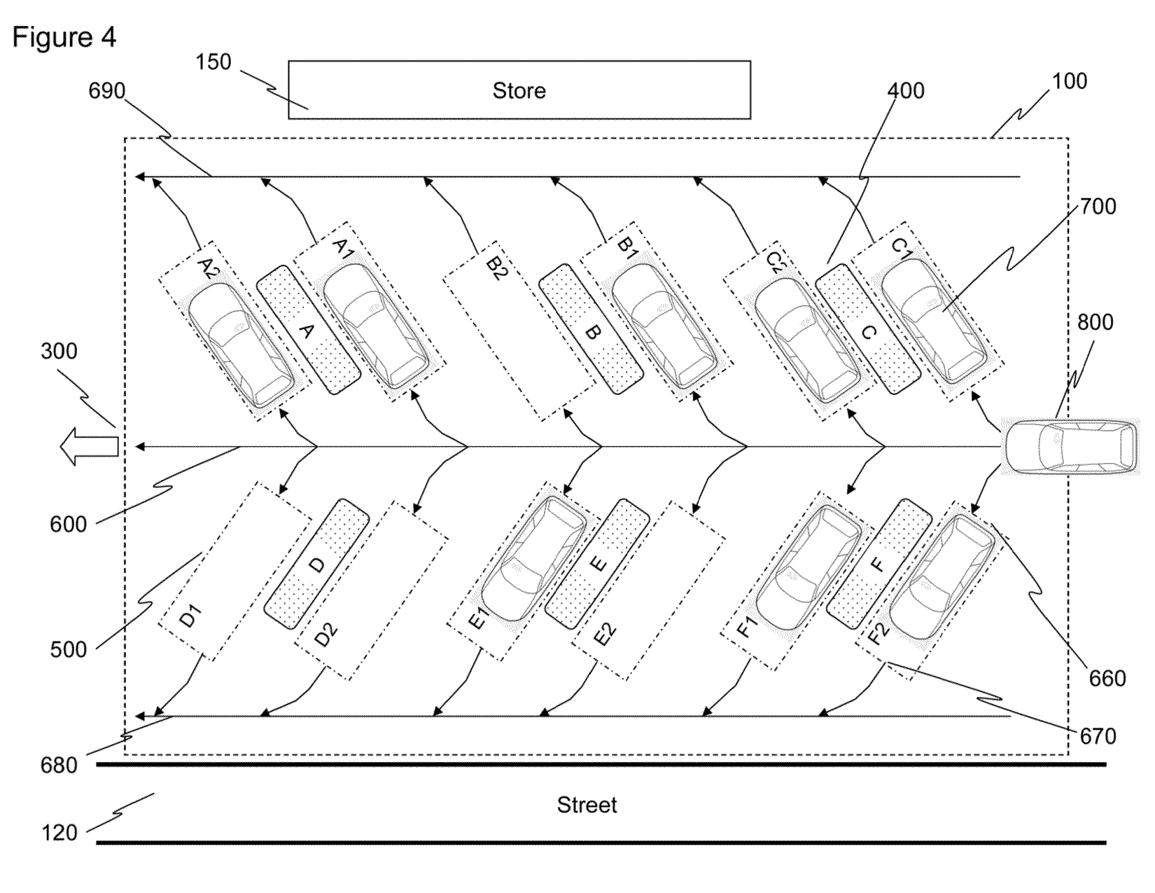

FIG. 4 illustrates an exemplary scenario in a fueling station according to this invention. Similar to the example as shown in FIG. 2, vehicles 700 have parked at the following eight fueling spaces for service: A1, B1, C1, A2, C2, E1, F1, and F2. Thus an incoming vehicle 800 will have four empty fueling spaces available to choose from: B2, D1, D2, and E2. Although the nearest fueling spaces C1, C2, F1, and F2 are all occupied, the incoming vehicle 800 is not obstructed from entering any of the four empty fueling spaces. Moreover, any of the eight vehicles occupying the fueling spaces can leave the fueling space after the completion of fueling through an adjacent passing lane without being blocked by another vehicle.

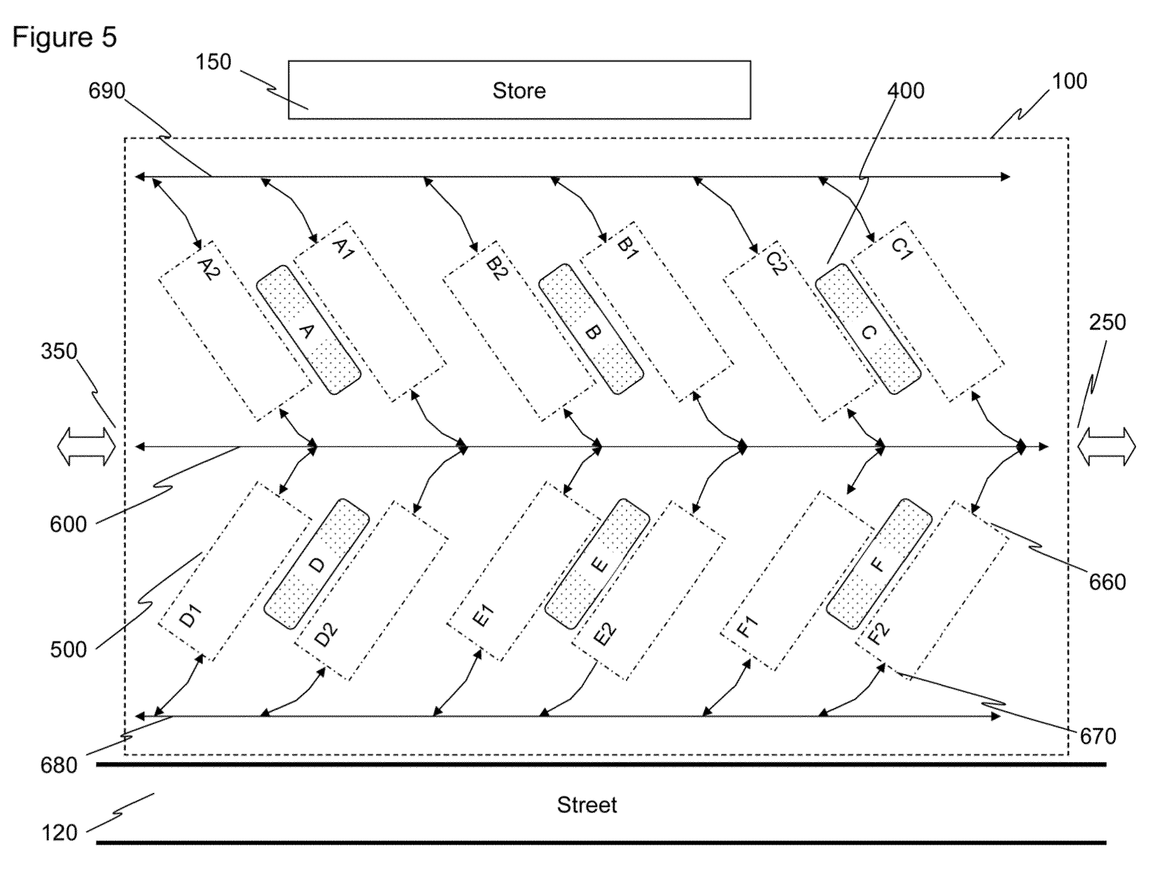

Although the traffic flow is shown to be unidirectional in the above examples, it should be understood that the same teaching is also applicable when the traffic flow is bidirectional, as illustrated in FIG. 5, where the direction of typical vehicle movement is shown by the solid arrows. As illustrated in this figure, the fueling station 100 has a first passage 250 for a vehicle to enter or exit, and a second passage 350 for a vehicle to enter or exit. In other words, vehicles can enter or exit the fueling station 100 from any of the available passages. Although not shown in the figure, it should be understood that the passages can be more than two, and the passages can be located at different sites along the peripheral of the fueling station. For example, a fueling station can have two passages for vehicles to enter and/or exit the fueling station, where the two passages do not need to he located on opposite sides of the fueling station.

Also as shown in this example, all passing lanes (600, 680, 690) are bidirectional, meaning the vehicles can drive along the passing lanes in both directions. In addition, each of the fueling space (e.g. F2) has a first end (e.g. 660) and a second end (e.g. 670), and both the first end and the second end can be used by a vehicle to enter or exit the fueling space. Therefore, a vehicle can enter any of the empty fueling space through one adjacent passing lane, and exit the same fueling space through another adjacent passing lane. In one example, an incoming vehicle can enter the fueling station 100 through the first passage 250, drive along the passing lane 600, then enter the fueling space F2 (if it is empty) through its first end 660, complete fueling, and then exit the fueling space F2 through its second end 670, drive along the passing lane 680, and exit the fueling station 100 through the second passage 350. In another example, the reverse route can be taken. That is, an incoming vehicle can enter the fueling station 100 through the second passage 350, drive along the passing lane 680, then enter the fueling space F2 (if it is empty) through its second end 670, complete fueling, and then exit the fueling space F2 through its first end 660, drive along the passing lane 600, and exit the fueling station 100 through the first passage 250.

While the invention has been described with reference to exemplary embodiments, it shall be understood by those skilled, in the art that various changes may be made and equivalents may be substituted without departing from the scope of the invention. In addition, many modifications may be made to adapt a particular situation or component to the teachings of the invention without departing from its scope. Therefore, it is intended that the invention not be limited to the particular embodiment disclosed, but that the invention will include all embodiments falling within the scope of the appended claims.

What are claimed are:

1. A vehicle fueling station comprising a passage for entrance, a passage for exit, at least a sequence of two or more fuel dispensers arranged sequentially between said passage for entrance and said passage for exit, wherein each fuel dispenser has at least one fueling space, and said fueling space is configured to enable a vehicle to move into and out of said fueling space without being hindered by another vehicle at a different fueling space.

2. The vehicle fueling station of claim 1, wherein each of said fueling spaces associated with said sequence of fuel dispensers is not connected with any other fueling spaces.

3. The vehicle fueling station of claim 1 comprises at least two passing lanes connecting said passage for entrance and said passage for exit.

4. The vehicle fueling station of claim 3, wherein each of said at least two passing lanes is connected to said sequence of fuel dispensers at different positions along said passing lane.

5. The vehicle fuelling station of claim 3, wherein each of said fueling spaces associated with said sequence of fuel dispensers is configured to have oblique angles with said at least two passing lanes.

6. The vehicle fueling station of claim 3, wherein each of said fueling spaces associated with said sequence of fuel dispensers has a first end connected to one of said passing lanes, and a second end connected to a different one of said passing lanes.

7. The vehicle fueling station of claim 6 is configured to provide a driving path for a vehicle enter said fueling station through said passage for entrance, drive along one of said passing lanes, enter any one of said fueling spaces connected to said passing lane, leave said fueling space, drive along a different one of said passing lanes, and exit said fueling station through said passage for exit.

8. A vehicle fueling station comprising a passage for entrance, a passage for exit, at least two passing lanes, wherein each passing lane provides a driving path between said passage for entrance and said passage for exit, two or more fuel dispensers arranged sequentially between said passage for entrance and said passage for exit, wherein each fuel dispenser has at least one fueling space, and said fueling space has a first end connected to one said passing lane, and a second end connected to a different said passing lane.

9. The vehicle fueling station of claim 8, wherein each of said fueling spaces associated with said sequentially arranged fuel dispensers is not connected with any other fueling spaces.

10. The vehicle fueling station of claim 8, wherein each of said at least two passing lanes is connected to said sequentially arranged fuel dispensers at different positions along said passing lane.

11. The vehicle fueling station of claim 8, wherein each of said fueling spaces associated with said sequentially arranged fuel dispensers is configured to have oblique angles with said at least two passing lanes.

12. The vehicle fueling station of claim 8 is configured to provide a driving path for a vehicle enter said fueling station through said passage for entrance, drive along one of said passing lanes, enter any one of said fueling spaces connected to said passing lane, leave said fueling space, drive along a different one of said passing lanes, and exit said fueling station through said passage for exit.

13. A method of improving traffic flow in a vehicle fueling station comprising providing a passage for entrance, providing a passage for exit, providing at least a sequence of two or more fuel dispensers arranged sequentially between said passage for entrance and said passage for exit, wherein each fuel dispenser has at least one fueling space, and said fueling space is configured to enable a vehicle to move into and out of said fueling space without being hindered by another vehicle at a different fueling space.

14. The method of improving traffic flow in a vehicle fueling station of claim 13, wherein each of said fueling spaces associated with said sequence of fuel dispensers is not connected with any other fueling spaces.

15. The method of improving traffic flow in a vehicle fueling station of claim 13 comprises providing at least two passing lanes connecting said passage for entrance and said passage for exit.

16. The method of improving traffic flow in a vehicle fueling station of claim 15, wherein each of said at least two passing lanes is connected to said sequence of fuel dispensers at different positions along said passing lane.

17. The method of improving traffic flow in a vehicle fueling station of claim 15, wherein each of said fueling spaces associated with said sequence of fuel dispensers is configured to have oblique angles with said at least two passing lanes.

18. The method of improving traffic flow in a vehicle fueling station of claim 15, wherein each of said fueling spaces associated with said sequence of fuel dispensers has a first end connected to one of said passing lanes, and a second end connected to a different one of said passing lanes.

19. The method of improving traffic flow in a vehicle fueling station of claim 18 comprises providing a driving path for a vehicle enter said fueling station through said passage for entrance, drive along one of said passing lanes, enter any one of said fueling spaces connected to said passing lane, leave said fueling space, drive along a different one of said passing lanes, and exit said fueling station through said passage for exit.
